(19) United States
(12) Patent Application Publication
(10) Pub. No.: US 2023/0135667 A1
(43) Pub. Date: May 4, 2023

(54) METHOD AND APPARATUS FOR PROVIDING NETWORK SLICE IN WIRELESS COMMUNICATION SYSTEM

(71) Applicant: Samsung Electronics Co., Ltd., Suwon-si (KR)

(72) Inventors: Hoyeon LEE, Suwon-si (KR); Dongeun SUH, Suwon-si (KR)

(21) Appl. No.: 17/975,140

(22) Filed: Oct. 27, 2022

(30) Foreign Application Priority Data
Oct. 28, 2021 (KR) 10-2021-0145775

(51) Int. Cl. H04W 60/04; H04W 48/02; H04W 76/10

(52) U.S. Cl. CPC H04W 60/04; H04W 48/02; H04W 76/10

(57) ABSTRACT

A method and an apparatus for providing a network slice in a wireless communication system are provided. The method includes transmitting a first message requesting registration of a user equipment (UE) to a first network entity via a base station (BS), receiving a second message including information indicating that the registration of the UE is accepted from the first network entity via the BS in response to the transmission of the first message, wherein the second message further includes information indicating an allowed network slice, and performing communication based on the information indicating the allowed network slice.

### CROSS-REFERENCE TO RELATED APPLICATION(S)

This application is based on and claims priority under 35 U.S.C. § 119(a) of a Korean patent application number 10-2021-0145775, filed on Oct. 28, 2021, in the Korean Intellectual Property Office, the disclosure of which is incorporated by reference herein in its entirety.

### BACKGROUND

### 1. Field

The disclosure relates to a wireless communication system. More particularly, the disclosure relates to a method and apparatus for providing a network slice in a wireless communication system.

### 2. Description of Related Art

In order to meet the demand for wireless data traffic soring since the 4^{th} generation (4G) communication system came to the market, there are ongoing efforts to develop enhanced 5^{th} generation (5G) communication systems or pre-5G communication systems. For the reasons, the 5G communication system or pre-5G communication system is called the beyond 4G network communication system or post long term evolution (LTE) system. The 5G communication system defined by 3^{rd} generation partnership project (3GPP) is called a new radio (NR) system.

For higher data transmit rates, 5G communication systems are considered to be implemented on ultra-high frequency bands (millimeter wave (mmWave)), such as, e.g., 60 GHz. To mitigate pathloss on the ultra-high frequency band and increase the reach of radio waves, the following techniques are taken into account for the 5G communication system beamforming, massive multi-input multi-output (MIMO), full dimensional MIMO (FD-MIMO), array antenna, analog beamforming, and large scale antenna, and these techniques are applied to the NR system.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (CoMP), and reception interference cancellation.

There are also other various schemes under development for the 5G system including, e.g., hybrid frequency shift keying (FSK) and quadrature amplitude modulation (QAM) (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

The Internet is evolving from the human-centered connection network by which humans create and consume information to the Internet of things (IoT) network by which information is communicated and processed between things or other distributed components. Another arising technology is the Internet of everything (IoE), which is a combination of the Big data processing technology and the IoT technology through, e.g., a connection with a cloud server. To implement the IoT, technology elements, such as a sensing technology, wired/wireless communication and network infra, service interface technology, and a security technology, are required. There is a recent ongoing research for inter-object connection technologies, such as the sensor network, machine-to-machine (M2M), or machine-type communication (MTC). In the IoT environment may be offered intelligent Internet technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of existing information technology techniques and various industries.

Thus, there are various ongoing efforts to apply the 5G communication system to the IoT network. For example, the sensor network, M2M, MTC, or other 5G techniques are implemented by schemes, such as beamforming, MIMO, and array antenna schemes. The above-mentioned application of the cloud RAN as a big data processing technique may be said to be an example of the convergence of the 5G and IoT technologies.

Along with the recent development of communication systems, various studies are underway to provide different network slicing (or network slices) in a 5G-based wireless communication system.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an efficient communication method and apparatus for providing a network slice in a wireless communication system.

Another aspect the disclosure is to provide a method and apparatus for providing a temporary service through network slicing in a 5^{th} generation (5G) network system structure.

Additional aspects will be set forth in part in the description which follows and, in part, will be apparent from the description, or may be learned by practice of the presented embodiments.

In accordance with an aspect of the disclosure, a method for providing a network slice by a user equipment (UE) in a wireless communication system is provided. The method includes transmitting a first message requesting registration of the UE to a first network entity via a base station (BS), receiving a second message including information indicating that the registration of the UE is accepted from the first network entity via the BS in response to the transmission of the first message, wherein the second message further includes information indicating an allowed network slice, and performing communication based on the information indicating the allowed network slice.

In accordance with another aspect of the disclosure, a method for providing a network slice by a first network entity in a wireless communication system is provided. The method includes receiving a first message requesting registration of a UE from the UE, transmitting a second message requesting UE subscription information to a second network entity in response to the reception of the first message, receiving a third message including the UE subscription information from the second network entity in response to the transmission of the second message, wherein the UE subscription information includes information indicating a network slice subscribed to by the UE and a prepaid network slice, and transmitting a fourth message including information indicating an allowed network slice to the UE based on the UE subscription information.

In accordance with another aspect of the disclosure, a method for providing a network slice by a second network entity in a wireless communication system is provided. The method includes transmitting a first message requesting subscription to an event related to a predetermined amount of available data of a subscribed network slice of a UE to a third network entity, in case that all data is used as much as the predetermined amount of available data of the subscribed network slice of the UE, receiving a second message including information related to use of the subscribed network slice of the UE in response to the transmission of the first message, and deleting a prepaid network slice from the subscribed network slice of the UE in response to reception of the second message.

In accordance with another aspect of the disclosure, a UE for providing a network slice in a wireless communication system is provided. The UE includes a transceiver, and a controller coupled to the transceiver. The controller is configured to transmit a first message requesting registration of the UE to a first network entity via a BS, receive a second message including information indicating that the registration of the UE is accepted from the first network entity via the BS in response to the transmission of the first message, wherein the second message further includes information indicating an allowed network slice, and perform communication based on the information indicating the allowed network slice.

In accordance with another aspect of the disclosure, a first entity for providing a network slice in a wireless communication system is provided. The first entity includes a transceiver and a controller coupled to the transceiver. The controller is configured to receive a first message requesting registration of a UE from the UE, transmit a second message requesting UE subscription information to a second network entity in response to the reception of the first message, receive a third message including the UE subscription information from the second network entity in response to the transmission of the second message, wherein the UE subscription information includes information indicating a network slice subscribed to by the UE and a prepaid network slice, and transmit a fourth message including information indicating an allowed network slice to the UE based on the UE subscription information.

In accordance with another aspect of the disclosure, a second entity for providing a network slice in a wireless communication system is provided. The second entity includes a transceiver and a controller coupled to the transceiver. The controller is configured to transmit a first message requesting subscription to an event related to a predetermined amount of available data of a subscribed network slice of a user equipment (UE) to a third network entity, in case that all data is used as much as the predetermined amount of available data of the subscribed network slice of the UE, receive a second message including information related to use of the subscribed network slice of the UE in response to the transmission of the first message, and delete a prepaid network slice from the subscribed network slice of the UE in response to reception of the second message.

According to various embodiments, a temporary service may be effectively provided in a wireless communication system by providing a method and apparatus for providing a network slice.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a system structure of a 5^{th} generation system (5GS) according to an embodiment of the disclosure;

FIG. 2 is a diagram illustrating a signal flow for a user equipment (UE) registration procedure according to an embodiment of the disclosure;

FIG. 3 is a diagram illustrating a signal flow for a protocol data unit (PDU) session establishment procedure using a public slice according to an embodiment of the disclosure;

FIG. 4 is a diagram illustrating a signal flow for a UE re-registration procedure according to an embodiment of the disclosure;

FIG. 5 is a diagram illustrating a signal flow for a procedure of changing an allowed network slice by a network according to an embodiment of the disclosure;

FIG. 6 is a diagram illustrating a signal flow for a network slice information update procedure according to an embodiment of the disclosure;

FIG. 7 is a flowchart illustrating an operation of a UE according to an embodiment of the disclosure;

FIG. 8 is a flowchart illustrating an operation of an access and mobility management function (AMF) according to an embodiment of the disclosure;

FIG. 9 is a flowchart illustrating an operation of a user data management (UDM)/unified data repository (UDR) according to an embodiment of the disclosure;

FIG. 10 is a block diagram illustrating a UE according to an embodiment of the disclosure;

FIG. 11 is a block diagram illustrating an AMF according to an embodiment of the disclosure; and

FIG. 12 is a block diagram illustrating a UDM/UDR according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The advantages and features of the disclosure, and a method for achieving them will become apparent from reference to embodiments described below in detail in conjunction with the attached drawings. However, the disclosure may be implemented in various manners, not limited to the embodiments set forth herein. Rather, these embodiments are provided such that the disclosure is complete and thorough and its scope is fully conveyed to those skilled in the art, and the disclosure is only defined by the appended claims. The same reference numerals denote the same components throughout the specification.

For the same reason, some components are exaggerated, omitted, or schematically illustrated in the drawings. The drawn size of each component does not exactly reflect its real size. In each drawing, the same reference numerals are assigned to the same or corresponding components.

It will be understood that each block of the flowchart illustrations and block diagrams, and combinations of blocks in the flowchart illustrations and/or block diagrams can be implemented by computer program instructions. These computer program instructions may be loaded on a processor of a general purpose computer, special purpose computer, or other programmable data processing equipment, such that the instructions, which are executed via the processor of the computer or other programmable data processing equipment, create means for implementing the functions specified in the flowchart block(s). These computer program instructions may also be stored in a computer-usable or computer-readable memory that can direct the computer or other programmable data processing equipment to function in a particular manner, such that the instructions stored in the computer-usable or computer-readable memory produce an article of manufacture including instruction means which implement the function/act specified in the flowchart and/or block diagram block(s). The computer program instructions may also be loaded onto the computer or other programmable data processing equipment to cause a series of operations to be performed on the computer or other programmable data processing equipment to produce a computer implemented process such that the instructions which are executed on the computer or other programmable equipment provide operations for implementing the functions/acts specified in the flowchart and/or block diagram block(s).

Furthermore, the respective block diagrams may illustrate parts of modules, segments, or codes including one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

The term “unit” as used herein means, but is not limited to, a software or hardware component, such as a field programmable gate array (FPGA) or application specific integrated circuit (ASIC), which performs certain tasks. A unit may advantageously be configured to reside on an addressable storage medium and configured to be executed on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided in the components and “units” may be combined into fewer components and “units” or further separated into additional components and “units”. In addition, the components and “units” may be implemented such that they are executed on one or more central processing units (CPUs) in a device or a secure multimedia card. Further, a “unit” may include one or more processors in embodiments.

In embodiments of the disclosure, a base station (BS), which is an entity to allocate resources to a user equipment (UE), may be at least one of a next generation Node B (gNode B or gNB), a evolved Node B (eNode B or eNB), a Node B, a radio access unit, a base station controller (BSC), or a network node. Further, the BS may be a network entity including at least one of an integrated access and backhaul (IAB)-donor that is a gNB providing network access to UE(s) through a network of backhaul and access links or an IAB-node that is a radio access network (RAN) node supporting NR access link(s) to UE(s) and supporting NR backhaul links to the IAB-donor or another IAB-node in a new radio (NR) system. A UE may be wirelessly coupled to an IAB-donor through an IAB-node and transmit and receive data to and from the IAB-donor coupled to at least one IAB-node via a backhaul link.

Further, the UE may include a terminal, a mobile station (MS), a cellular phone, a smart phone, a computer, or various devices capable of executing a communication function. In the disclosure, downlink (DL) is a wireless transmission path of a signal transmitted from a BS to a UE, and uplink (UL) is a wireless transmission path of a signal transmitted from a UE to a BS. While a long term evolution (LTE) or LTE-advanced (LTE-A) system may be described below as an example, embodiments of the disclosure are applicable to other communication systems having a similar technical background or channel structure. For example, the communication systems may include 5^{th} generation (5G) new radio (5G NR) developed after LTE-A, and 5G may be a concept encompassing legacy LTE, legacy LTE-A, and other similar services in the following description. Further, the disclosure is also applicable to other communication systems through some modifications without greatly departing from the scope of the disclosure as judged by those skilled in the art.

The disclosure relates to a method and apparatus for supporting various services in a wireless communication system. Specifically, the disclosure describes a technique of supporting various services by managing registration of a UE that intends to use a network slice in a wireless communication system.

Terminology identifying an access node, terminology signifying network entities or network functions (NFs), terminology signifying messages, terminology signifying interfaces between network entities, and terminology signifying various types of identification information as used in the following description are given for convenience of description. Accordingly, the disclosure is not limited to the terms described below, and the terms may be replaced by other equivalent terms in technical meanings.

For convenience of description, the disclosure uses terms and names defined in the 3^{rd} generation partnership project (3GPP) LTE and 5G standards. However, the disclosure is not limited by the above terms and names. Accordingly, the terms or names defined in the disclosure may be equally applied to systems conforming to other standards.

For convenience of description, the names of NFs (e.g., access and mobility management function (AMF), session management function (SMF), network slicing selection function (NSSF), and so on) are used to indicate entities for exchanging information for access control and state management. However, embodiments of the disclosure are equally applicable even when NFs are actually implemented as instances (AMF instance, SMF instance, NSSF instance, and so on).

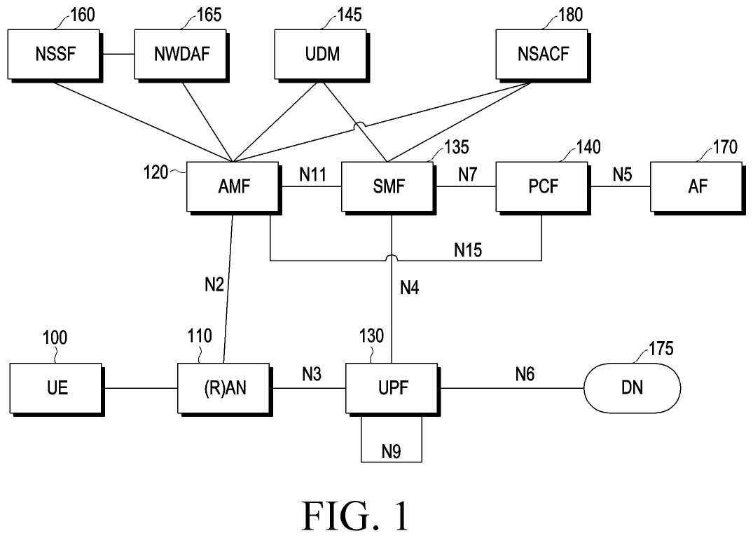

FIG. 1 illustrates a system structure of a 5G system (5GS) according to an embodiment of the disclosure.

The 5GS may include a 5G core network, a BS, and a UE. The 5G core network may include an AMF 120, an SMF 135, a user plane function (UPF) 130, a policy control function (PCF) 140, a user data management (UDM) 145, an NSSF 160, a network data analytics function (NWDAF) 165, a non-3GPP function (N3F), and so on.

A UE 100 may access the 5G core network through a radio access network (RAN) BS (hereinafter, referred to as a BS) 110. The BS 110 may support a 3GPP access network type (e.g., NR, evolved UMTS terrestrial radio access (E-UTRA), and so on) or a non-3GPP access network type (e.g., wireless fidelity (Wi-Fi)). The UE 100 may be coupled to the AMF 120 via an N2 interface and to the UPF 130 via an N3 interface, via the BS 110. The BS 110 may also be referred to as “access point (AP),” “eNodeB or eNB,” “5G node,” “gNodeB or gNB,” or other terms having an equivalent technical meaning. The N3F is an NF that operates as an N2 interface and N3 interface termination for the UE 100 that has accessed through a non-3GPP access network (e.g., Wi-Fi or the like) not defined by the 3GPP. The N3F may process N2 control-plane signaling and N3 user-plane packets.

The AMF 120 is an NF that manages wireless network access and mobility for a UE. The AMF provides a function for access and mobility management on a UE basis, and basically, one AMF may be coupled to one UE.

The SMF 135 is an NF that manages a session for a UE, and session information includes quality of service (QoS) information, charging information, and packet processing information. The SMF 135 provides a session management function, and when the UE has a plurality of sessions, each session may be managed by a different SMF. The AMF 120 and the SMF 135 may be coupled to each other via an N11 interface.

The UPF 130 is an NF that processes user traffic (user-plane traffic), and is controlled by the SMF 135. The UPF 130 forwards a DL PDU received from a data network (DN) 175 to the UE 100 via the BS 110, and forwards a UL PDU received from the UE 100 to the DN 175 via the BS 110. The UPF 130 and the SMF 135 may be coupled to each other via an N4 interface. When a plurality of UPFs exist, the UPFs may be coupled to each other via an N9 interface.

The PCF 140 is an NF that manages an operator policy for providing a service in the wireless communication system. The PCF 140 receives packet flow information from an application server and provides a function of determining policies such as mobility management and session management. Specifically, the PCF 140 supports functions including support of a unified policy framework for controlling network operations, provision of policy rules to allow control-plane function(s) (e.g., the AMF 120, the SMF 135, and so on) to enforce policy rules, and implementation of a front end for accessing related subscription information for policy making in a UDR. The PCF 140 and the SMF 135 may be coupled to each other via an N7 interface. The PCF 140 and the AMF 120 may be coupled to each other via an N15 interface.

The UDM 145 is an NF that stores and manages UE subscription information. A UDR is an NF that stores and manages data. The UDR may store UE subscription information and provide the UE subscription information to the UDM. In addition, the UDR may store operator policy information and provide the operator policy information to the PCF.

The NSSF 160 selects an optimal network slice serviceable for a user-requested service in a 5G network environment that provides various services, and provides an optimal AMF capable of supporting a requested service allowed to the user by the network.

The NWDAF 165 is an NF that provides analysis information to operate the 5G system. The NWDAF may collect data from another NF or an operations, administration, and maintenance (OAM) included in the 5GS, analyze the collected data, and provide analysis results to the other NF.

An application function (AF) 170 interacts with a 3GPP core network in order to provide services (e.g., to support the following: application influence on traffic routing, accessing network capability exposure, and interacting with the policy framework for policy control). The AF 170 and the PCF 140 may be coupled to each other via an N5 interface.

The DN 175 refers to an operator service, Internet access, or a third party service. The DN may transmit a DL PDU to the UPF or receive a PDU transmitted by the UE 100 from the UPF 130. The UPF 130 and the DN 175 may be coupled to each other via an N6 interface.

A network slice admission control function (NSACF) 180 is an NF that monitors and controls the number of registered UEs and the number of sessions of a network slice subject to network slice admission control (NSAC). The NSACF stores configuration information about a maximum number of registered UEs and a maximum number of sessions for each network slice.

For convenience of description, entities for exchanging information for access control and state management will be generically described as NFs. However, embodiments of the disclosure are equally applicable even when NFs are actually implemented as instances (AMF instance, SMF instance, NSSF instance, and so on, respectively).

In the disclosure, an instance may refer to a state in which a specific NF exists in the form of software code, and is executable by physical and/or logical resource allocation for executing a function of the NF from a physical computing system, for example, a specific computing system existing on a core network. Therefore, an AMF instance, an SMF instance, and an NSSF instance may mean that physical and/or logical resources are allocated and usable for AMF, SMF, and NSSF operations from a specific computing system existing on the core network, respectively. As a result, physical AMF, SMF, and NSSF devices may perform the same operations as AMF, SMF, and NSSF instances using physical and/or logical resources allocated for AMF, SMF, and NSSF operations by a specific computing system existing on the network. Therefore, in an embodiment of the disclosure, the term NF (AMF, SMF, UPF, NSSF, NRF, SCP, and so on) may be replaced with NF instance, or vice versa. Likewise, the term network slice may be replaced with network slice instance, or vice versa in an embodiment of the disclosure. Further, in an embodiment of the disclosure, a slice refers to a network slice. For example, a public slice means a public network slice. In addition, a subscribed slice means a subscribed network slice, and an allowed slice means an allowed network slice. A prepaid slice means a prepaid network slice.

According to an embodiment of the disclosure, in the 5G system defined by the 3GPP, one network slice may be referred to as single-network slice selection assistance information (S-NSSAI). The S-NSSAI may include a slice/service type (SST) and a slice differentiator (SD). The SST may indicate the features (e.g., enhanced mobile broadband (eMBB), Internet of things (IoT), ultra-reliable low-latency communication (URLLC), vehicle to everything (V2X), or the like) of a service supported by the slice. The SD may be a value used as an additional identifier (ID) for the specific service indicated by the SST.

An NSSAI may include one or more S-NSSAIs. Examples of the NSSAI may include, but not limited to, a configured NSSAI stored in a UE, a requested NSSAI requested by a UE, an allowed NSSAI that is allowed to be used by a UE, as determined by an NF (e.g., the AMF 120, the NSSF 160, or the like) of the 5G core network, and a subscribed NSSAI to which a UE has subscribed.

According to an embodiment of the disclosure, a mobile communication operator may provide an available slice under a specific condition. For example, the mobile communication operator may provide a public slice available for a specific location, a specific time, a specific period, a specific application (service), and so on regardless of subscription information about a specific UE. Alternatively, for example, the mobile communication operator may provide a slice based on prepayment information. The slice based on the prepayment information may be a slice available for a specific location, a specific time, a specific period, a specific application (service), and a predetermined amount of available data.

The UE 100 may be simultaneously coupled to the access network (RAN)/BS 110 and registered in the 5G system. Specifically, the UE 100 may access the BS 110 and perform a UE registration procedure with the AMF 120. During the registration procedure, the AMF 120 may determine an allowed network slice (allowed NSSAI) available to the UE 100 that has accessed the BS 110, and allocate the allowed network slice to the UE 100.

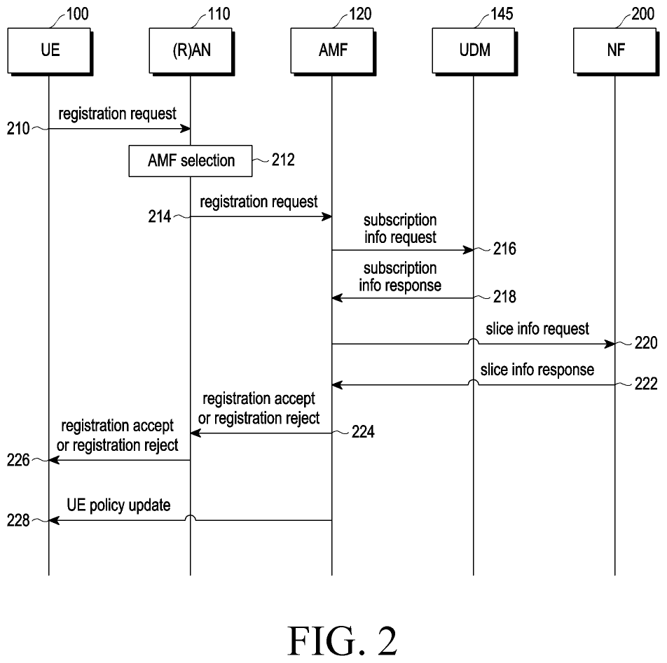

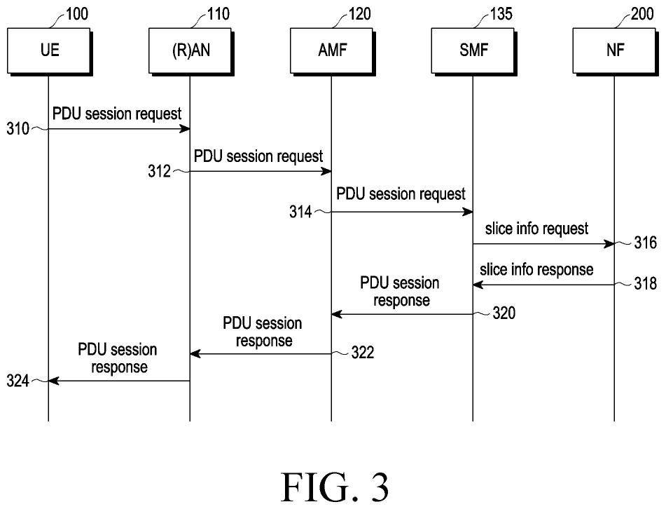

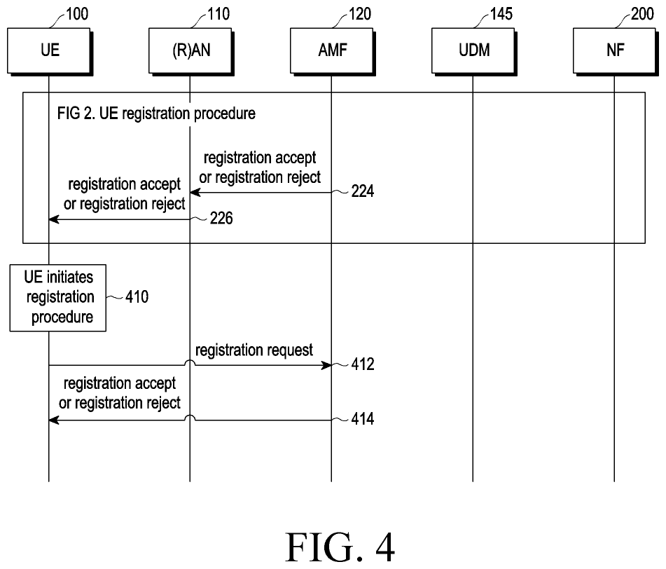

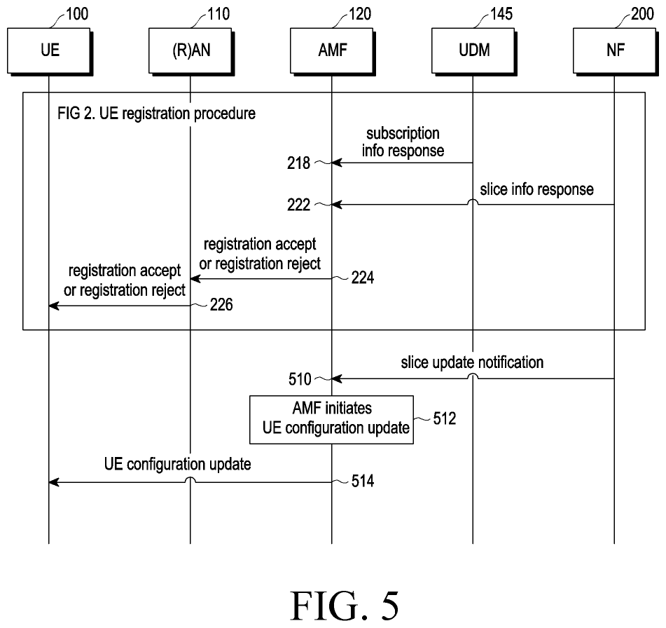

FIG. 2 illustrates a UE registration procedure according to an embodiment of the disclosure.

Referring to FIG. 2, the UE 100 according to an embodiment of the disclosure may access the BS 110 and perform the registration procedure with the AMF 120.

Step 210: The UE 100 may access the BS 110 and transmit a registration request message. The registration request message may include information (requested NSSAI, e.g., S-NSSAI 1 and S-NSSAI 2) about a requested slice that the UE intends to use. Further, the registration request message may include location information (e.g., a tracking area identity (TAI), a cell identity (cell ID), or the like) about the UE.

Step 212: Upon receipt of the registration request message, the BS 110 according to an embodiment of the disclosure may select an AMF to which a registration request is to be transmitted, based on the information (requested NSSAI) about the requested network slices that the UE intends to use, received from the UE 100. For example, the BS 110 may select an AMF capable of supporting the requested NSSAI.

Step 214: The BS 110 may transmit an N2 message to the AMF 120 selected in step 212. The N2 message may include the registration request message. Further, the N2 message may include N2 parameters. The N2 parameters may include the location information (e.g., the TAI, the cell ID, or the like) about the UE. The AMF 120 may need to obtain UE subscription information to process the registration request message.

Step 216: The AMF 120 may transmit a subscription info request message to the UDM 145 to request the UE subscription information. The subscription info request message may include a UE ID (e.g., a subscription permanent identifier (SUPI), a 5G-globally unique temporary identifier (5G-GUTI), or the like). The subscription info request message may further include the location information about the UE.

Step 218: The UDM 145 may respond to the AMF 120 with a subscription info response message including UE subscription information corresponding to the UE ID. The UE subscription information may include information (subscribed S-NSSAIs) about a subscribed slice to which the UE 100 has subscribed. For example, the information about the subscribed slice to which the UE 100 has subscribed may include S-NSSAI 1, S-NSSAI 2, S-NSSAI 3, and S-NSSAI 4.

The UDM 145 according to an embodiment of the disclosure may store and manage public slice information. A public slice may be a slice available for a specific location, a specific time, a specific period, a specific application (service), and so on, regardless of subscription information about a specific UE. The UDM 145 may determine whether to provide a public slice based on at least one of an operator policy configured in the UDM or the information received from the AMF 120. For example, the UDM 145 may determine that there is a public slice available at a current location of the UE based on current location information about the UE. Alternatively, for example, the UDM 145 may determine that there is a public network slice available at a current time. In this case, the subscription info response message transmitted to the AMF 120 by the UDM 145 may include public slice information. The public slice information may include information such as an indicator (e.g., S-NSSAI) indicating the slice, a slice available location, time, period, and application (service), and so on. Alternatively, the public slice information may include an indicator indicating that a public slice is available.

Step 220: The AMF 120 according to an embodiment of the disclosure may determine whether to provide a public slice based on at least one of an operator policy configured in the AMF, the information received from the UDM 145, or the information received from the UE 100. For example, the AMF 120 may determine that there is a public slice available at the current location of the UE based on the current location information about the UE. Alternatively, for example, the AMF 120 may determine that there is a public slice available at the current time. Alternatively, for example, the AMF 120 may determine that there is an available public slice based on the information (e.g., the indicator indicating that a public slice is available) received from the UDM 145.

Upon determination that there is an available public slice, the AMF 120 may transmit a slice info request message requesting slice information to the NF 200 that manages public slice information. The NF 200 may be one of NFs included in the 5G core network illustrated in FIG. 1 or a new NF. When the UDM 145 manages slice information, steps 220 and 222 may be omitted, and the public slice information may be provided to the AMF 120 in step 218. The slice info request message may include information (e.g., location information or the like) required to determine whether a public slice is available.

Alternatively, the AMF 120 according to an embodiment of the disclosure may store and manage the public slice information. When the AMF 120 manages the slice information, steps 220 and 222 may be omitted. A public slice may be a slice available for a specific location, a specific time, a specific period, a specific application (service), and so on, regardless of subscription information about a specific UE. The AMF 120 may determine whether to provide the public slice based on at least one of the operator policy configured in the AMF or the information received from the UE 100. For example, the AMF 120 may determine that there is a public slice available at the current location of the UE based on the current location information about the UE. Alternatively, for example, the AMF 120 may determine that there is a public slice available at the current time. The public slice information managed by the AMF 120 may include information such as an indicator (e.g., S-NSSAI) indicating the slice, a slice available location, time, period, and application (service), and so on.

Step 222: The NF 200 according to an embodiment of the disclosure may store and manage public slice information. A public slice may be a slice available for a specific location, a specific time, a specific period, a specific application (service), and so on, regardless of subscription information about a specific UE. The NF 200 may determine whether to provide the public slice based on at least one of an operator policy configured in the NF or the information received from the AMF 120. For example, the NF 200 may determine that there is a public slice available at the current location of the UE based on the current location information about the UE. Alternatively, for example, the NF 200 may determine that there is a public slice available at the current time. In this case, the slice info response message transmitted to the AMF 120 by the NF 200 may include public slice information. The public slice information may include information such as an indicator (e.g., S-NSSAI) indicating the slice, a slice available location, time, period, and application (service), and so on.

Step 224: The AMF 120 may determine an allowed slice (allowed NSSAI) based on at least one of the requested slice (requested NSSAI) of the UE, a network slice (S-NSSAI supported by RAN) supported by a UE access network (3GPP AN) and the BS 110, or an operator policy.

For example, the AMF 120 may identify whether the requested slice (e.g., S-NSSAI 1 and S-NSSAI 2) of the UE is included in the subscribed slice (e.g., S-NSSAI 1, S-NSSAI 2, S-NSSAI 3, and S-NSSAI 4) of the UE. In addition, the AMF 120 may identify whether the requested slice (e.g., S-NSSAI 1 and S-NSSAI 2) of the UE is included in network slices supported at the current location of the UE by the BS 110 (e.g., S-NSSAIs supported by a TA, which are S-NSSAI 1, S-NSSAI 2, and S-NSSAI 3).

The AMF 120 may determine to include slices of the requested slice (e.g., S-NSSAI 1 and S-NSSAI 2), which are included in the subscribed slice (e.g., S-NSSAI 1, S-NSSAI 2, S-NSSAI 3, and S-NSSAI 4) of the UE and in the slices (e.g., S-NSSAI 1, S-NSSAI 2, and S-NSSAI 3) supported at the current location of the UE, in the allowed slice (e.g., S-NSSAI 1 and S-NSSAI 2).

Further, the AMF 120 may determine that the public slice may be provided to the UE 100 based on at least one of configuration information stored in the AMF 120, the information received from the UDM 145, or the information received from the NF 200. Accordingly, the AMF 120 may include public slice information in information about the allowed slice. For example, the AMF 120 may determine to add the public slice (e.g., S-NSSAI 10) to the allowed slice (e.g., S-NSSAI 1 and S-NSSAI 2) determined based on the UE subscription information. Accordingly, the information (e.g., S-NSSAI 1, S-NSSAI 2, and S-NSSAI 10) about the allowed slice may include the information about the slices based on the UE subscription information, and the public slice information. That is, the information about the allowed slice may include not only the requested slice (e.g., S-NSSAI 1 and S-NSSAI 2) of the UE but also the information (e.g., S-NSSAI 10) about the slice available to the UE.

In addition, the AMF 120 may determine a registration area (RA) in the UE registration procedure. The RA may include one or more tracking areas (TAs) in which the allowed slice is usable. That is, the RA may indicate information about a location in which the public slice included in the allowed slice as well as the allowed slice based on the UE subscription information is usable.

The AMF 120 may transmit a registration accept message or a registration reject message to the UE 100 in response to the registration request message. The registration accept message may include the information (allowed NSSAI) about the allowed slice and the information about the RA. Further, the registration accept message may include public slice information. The public slice information may include information about a location, a time, a period, and an application (service) in which the public slice (e.g., S-NSSAI) is usable. The public slice information may be information about the public slice included in the allowed slice. Alternatively, the public slice information may include information about a public slice not included in the allowed slice.

When no slice is available to the UE, that is, in the absence of an allowed slice, the AMF 120 may transmit a registration reject message.

Step 226: The BS 110 may transmit the registration accept message or the registration reject message received from the AMF 120 to the UE 100. Upon receipt of the registration accept message, the UE 100 may store the information (allowed NSSAI) about the allowed slice, included in the registration accept message.

Upon receipt of the registration accept message, the UE 100 may obtain information about the available public slice based on the information included in the registration accept message. For example, the UE 100 may identify that the public slice is available based on the slice (e.g., S-NSSAI 10) other than the requested slice (e.g., S-NSSAI 1 and S-NSSAI 2) being included in the allowed slice. When additional public slice information (e.g., the location, time, period, and application (service) in which the public slice (e.g., S-NSSAI) is usable) is included in the registration accept message, the UE 100 may identify the location, time, period, and application (service) in which the public slice (e.g., S-NSSAI) is usable. When the additional public slice information (e.g., the location, time, period, and application (service) in which the public slice (e.g., S-NSSAI) is usable) is not included in the registration accept message, the UE 100 may determine that the public slice is available at the current location and time.

The additional public slice information or at least part of the additional public slice information may be transmitted to the UE 100 in a separate message from the registration accept message. In this case, step 228 may be performed.

Step 228: The AMF 120 may transmit the public slice information in a message separate from the registration accept message to the UE 100. The public slice information may include at least one of the location, time, period, or application (service) in which the public slice (e.g., S-NSSAI) is available. For example, the AMF 120 may determine public slice information to be provided to the UE 100, based on at least one of the configuration information stored in the AMF, the information received from the UDM 145, or the information received from the NF 200. Alternatively, for example, the AMF 120 may obtain the public slice information from at least one (e.g., PCF) of the NFs included in the 5G core network of FIG. 1. For example, the PCF may store and manage information about an application (service) for which the public slice is available, and provide the information to the AMF 120.

The AMF 120 may transmit the public slice information to the UE 100. The public slice information may specify at least one of the location, time, period, or application (service) in which the public slice is available. The UE 100 may identify the location, time, period, or application (service) in which the public slice is available, based on the public slice information.

While not illustrated in the drawing, the UE 100 may then perform a PDU session establishment procedure or a UE re-registration procedure. The PDU session establishment procedure will be described later with reference to FIG. 3. For the UE re-registration procedure, FIG. 4 to be described later is referred to.

FIG. 3 illustrates a PDU session establishment procedure using a public slice according to an embodiment of the disclosure.

Step 310: The UE 100 registered in the network through the procedure illustrated in FIG. 2 may access the BS 110 and transmit a PDU session request message requesting a PDU session. The UE 100 may determine to establish a PDU session using the public slice (e.g., S-NSSAI 10). For example, the UE 100 may determine to use the public slice for a current location, time, and a specific application (service). The UE 100 may include the public slice (e.g., S-NSSAI 10) that the UE intends to use in the PDU session request message. The slice may be one of S-NSSAIs included in the allowed slice.

Step 312: Upon receipt of the PDU session request message, the BS 110 according to an embodiment of the disclosure may transmit a PDU session request message to the AMF 120 serving the UE 100.

Step 314: The AMF 120 according to an embodiment of the disclosure may determine that the public slice (e.g., S-NSSAI 10) requested by the UE for PDU session establishment is a public slice.

The AMF 120 may transmit a PDU session request message to the SMF 135. The PDU session request message may include the S-NSSAI requested by the UE. In addition, the PDU session request message may include an indicator indicating that the S-NSSAI requested by the UE is a slice to which an exception is applicable (e.g., the S-NSSAI requested by the UE is a public slice).

Upon receipt of the PDU session request message from the AMF 120, the SMF 135 may perform a PDU session establishment procedure. The SMF 135 may determine whether the S-NSSAI requested by the UE is a slice included in UE subscription information, based on the UE subscription information obtained from the UDM. When the S-NSSAI requested by the UE is not a slice included in the UE subscription information, the SMF 135 may reject the PDU session request. When receiving the indicator indicating that the S-NSSAI requested by the UE is a slice to which an exception is applicable (e.g., the S-NSSAI requested by the UE is a public slice) from the AMF 120, the SMF 135 may determine to perform the PDU session request procedure (accept the PDU session request), even though the S-NSSAI requested by the UE is not a slice included in the UE subscription information.

According to another embodiment, the SMF 135 may obtain public slice information from the NF 200. For example, the NF 200 may be the UDM 145. In this case, steps 316 and 318 may be performed.

Step 316: The SMF 135 may transmit a slice info request message to request public slice information from the NF 200.

Step 318: The NF 200 may transmit a slice info response message to the SMF 135. The slice info response message may include the UE subscription information. The UE subscription information may include the public slice information. In this case, the SMF 135 may determine to perform the PDU session request procedure (accept the PDU session request) because the S-NSSAI requested by the UE is included in slices included in the UE subscription information. Alternatively, for example, the NF 200 may be at least one of the NFs included in the 5G core network illustrated in FIG. 2. The SMF 135 may obtain the public slice information from the NF 200. In this case, since the S-NSSAI requested by the UE is a public slice, the SMF 135 may determine to perform the PDU session request procedure (accept the PDU session request).

Step 320: The SMF 135 that has determined to accept the PDU session establishment may transmit a PDU session response message to the AMF 120.

Step 322: The AMF 120 may transmit the PDU session response message to the UE 100 via the BS 110.

Step 324: The BS 110 may transmit the PDU session response message received from the AMF 120 to the UE 100. Upon receipt of the PDU session response message, the UE 100 may transmit/receive data using a PDU session established in association with the public slice.

The PDU session establishment procedure of FIG. 3 may be performed after the UE registration procedure of FIG. 2.

FIG. 4 illustrates a UE re-registration procedure according to an embodiment of the disclosure. FIG. 4 illustrates a method for providing a UE with information about a time and a location at which a public slice is available, and staring the re-registration procedure accordingly by the UE.

Referring to FIG. 4, the UE 100 and the 5G core network according to an embodiment of the disclosure may exchange public slice information with each other through the procedure illustrated in FIG. 2.

In steps 224 and 226, the AMF 120 may transmit a message including the public slice information to the UE 100.

The public slice information may include slice available time information. The slice available time information may take various forms. For example, the slice available time information may be an absolute time value. The absolute time value may be expressed as a start time and an end time (e.g., 00:00 on month x, day x to 00:00 on month y, day y) at which the slice is available. Alternatively, for example, the slice available time information may be a timer value. The timer value may be represented as a time duration (e.g., y hours or the like) from a current time to an end time of slice use. Alternatively, for example, the slice available time information may be represented using both an absolute time value and a timer value. The absolute time value and the timer value may be represented as a time duration until an end time at which the slice is terminated from a start time at which the slice is available (e.g., y hours from month x day x).

The public slice information may include slice available location information. The slice available location information may take various forms. For example, the slice available location information may include a TA. Information about one or more TAs supporting the public slice (S-NSSAI) may be included. Alternatively, for example, the slice available location information may be global positioning system (GPS) information or the like.

The UE 100 may store the received public slice information.

Step 410: The UE registered in the 5G network through the procedure illustrated in FIG. 2 may then determine to perform the UE registration procedure again. For example, the UE 100 may identify that there is a public slice available at a current location and/or current time of the UE based on the information received in steps 224 and 226. Alternatively, the UE 100 may identify that a public slice used by the UE is no longer available based on the information received in steps 224 and 226.

Step 412: The UE 100 may transmit a registration request message to the AMF 120 in order to use an available public slice or update unavailable public slice information. The registration request message may include information (requested NSSAI) about a requested slice including a public slice that the UE intends to use.

Step 414: The AMF 120 may process the registration request message received from the UE 100. The AMF 120 may determine an allowed slice of the UE in a similar manner to the method illustrated in FIG. 2. That is, a public slice available to the UE may be included in the allowed slice. The AMF 120 may transmit a registration accept message including information about a new allowed slice (new allowed NSSAI) to the UE 100. The information about the new allowed slice may be the same as the information (allowed NSSAI) about the allowed slice described in FIG. 2. In the absence of an available public slice for the UE, that is, in the absence of any new allowed slice, the AMF 120 may transmit a registration reject message to the UE 100.

The UE re-registration procedure in step 410 disclosed in FIG. 4 may be performed before or after the PDU session establishment procedure of FIG. 3. The re-registration procedure of the UE in step 410 of FIG. 4 may be performed even though the PDU session establishment procedure of FIG. 3 is not performed. However, the UE re-registration procedure of step 410 in FIG. 4 may be performed after the UE registration procedure of FIG. 2.

FIG. 5 illustrates a slice information update procedure according to an embodiment of the disclosure. FIG. 5 illustrates a method for changing an allowed slice by a network based on information about a time, a location, and so on at which a public slice is available.

Referring to FIG. 5, the 5G core network according to an embodiment of the disclosure may transmit and receive public slice information through the procedure illustrated in FIG. 2.

The AMF 120 may obtain public slice information from the NF 200 (or the UDM 145). Alternatively, the AMF 120 may have the public slice information stored as an operator policy or configuration information.

The public slice information may include slice available time information. The slice available time information may take various forms. For example, the slice available time information may be an absolute time value. The absolute time value may be expressed as a start time and an end time (e.g., 00:00 on month x, day x to 00:00 on month y, day y) at which the slice is available. Alternatively, for example, the slice available time information may be a timer value. The timer value may be represented as a time duration (e.g., y hours or the like) from a current time to an end time of slice use. Alternatively, for example, the slice available time information may be represented using both an absolute time value and a timer value. The absolute time value and the timer value may be represented as a time duration until an end time at which the slice is terminated from a start time at which the slice is available (e.g., y hours from month x day x).

The public slice information may include slice available location information. The slice available location information may take various forms. For example, the slice available location information may include a TA. Information about one or more TAs supporting the public slice (S-NSSAI) may be included. Alternatively, for example, the slice available location information may be GPS information or the like.

In steps 224 and 226, the AMF 120 may transmit a registration accept message to the UE 100. The registration accept message may include information about an allowed slice including information about a public slice currently available to the UE. In this case, the registration accept message may not include information about a public slice other than the allowed slice.

Step 510: The NF 200 (or the UDM 145) according to an embodiment of the disclosure may transmit public slice change information to the AMF 120. For example, at a time when the public slice becomes available, the NF 200 may transmit a notification message to notify the AMF 120 that the public slice is available. Alternatively, when a public slice that has been provided is no longer available, the NF 200 may transmit a slice update notification message to notify the AMF 120 that the public slice is unavailable.

Step 512: After transmitting the information about the allowed slice to the UE registered in the 5G network through the procedure illustrated in FIG. 2, the AMF 120 may determine to update the public slice information (update a UE configuration). For example, the AMF 120 may identify that the public slice information has been changed based on the information received in step 218, step 222, or step 510. The allowed slice (allowed NSSAI) includes the public slice (S-NSSAI). That is, the public slice may be included as one of the S-NSSAIs included in the allowed slice.

Further, the AMF 120 may determine that the allowed slice indicated to the UE in steps 224 and 226 needs to be changed. For example, when the public slice (e.g., S-NSSAI 10) included in the allowed slice indicated to the UE in steps 224 to 226 is no longer available, the AMF 120 may determine to delete the public slice from the allowed slice.

Step 514: The AMF 120 may transmit a UE configuration update message including a new allowed slice (new allowed NSSAI) without the public slice to the UE 100.

The procedure of changing an allowed slice by the network in step 510 of FIG. 5 may be performed before or after the PDU session establishment procedure of FIG. 3. The procedure of changing an allowed slice by the network in step 510 of FIG. 5 may be performed even though the PDU session establishment procedure of FIG. 3 is not performed. However, the procedure changing an allowed slice by the network in step 510 of FIG. 5 may be performed after the UE registration procedure of FIG. 2 is performed.

According to an embodiment of the disclosure, a mobile communication service provider may provide a slice based on prepayment information. Information about the slice based on the prepayment information may be stored in the UDM 145. A mobile communication system according to an embodiment of the disclosure may provide a slice based on prepayment information in a similar manner to the method of providing a public slice illustrated in FIGS. 2 to 5.

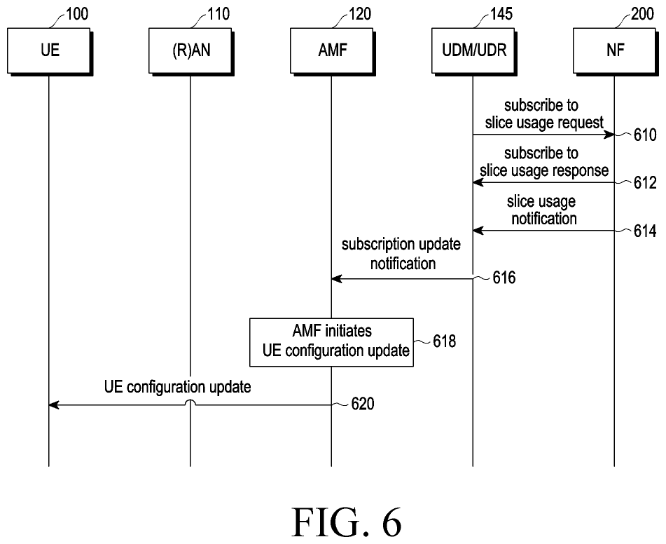

FIG. 6 illustrates a slice information update procedure according to an amount of available slice data according to an embodiment of the disclosure.

A mobile communication operator may provide a slice based on prepayment information. The slice based on the prepayment information may be a slice available as much as a predetermined amount of available data. The mobile communication system may perform the procedure illustrated in FIG. 6 to monitor a data usage using the slice and update information about the slice, when the predetermined amount of available data is exceeded.

Step 610: The UDM/UDR 145 according to an embodiment of the disclosure may store slice information based on prepayment information of the UE 100. The slice information based on the prepayment information may include information about an amount of available data to the UE 100. The UDM/UDR 145 may transmit a subscribe to slice usage request message to the NF 200 in order to monitor information about a data usage used by the UE 100. The NF 200 may be at least one of NFs included in the 5G core network illustrated in FIG. 2. Alternatively, the NF 200 may be a charging function (CHF) in charge of charging. Alternatively, the NF 200 may be a UPF that manages data traffic transmission. Alternatively, the NF 200 may be an NWDAF that manages data statistics. The subscribe to slice usage request message may include at least one of a UE ID, information (e.g., S-NSSAI) about a target slice to be monitored, or a condition for receiving a notification message (e.g., information about a data usage threshold, and so on). The data usage threshold may be set to a prepaid amount of available data. Alternatively, the data usage threshold may be set to a value less or greater than the prepaid amount of available data.

Step 612: The NF 200 may store the received subscribe to slice usage request message. The NF 200 may monitor the slice usage of the UE. In response to the subscribe to slice usage request message, the NF 200 transmits a subscribe to slice usage response message to the UDM/UDR 145.

Step 614: When the slice usage of the UE satisfies the condition for receiving the notification message, received in step 610 (e.g., the information about the threshold of data usage, and so on), the NF 200 may transmit a slice usage notification message to the UDM/UDR 145.

Step 616: The UDM/UDR 145 may determine whether to update the slice information based on the slice usage notification message received from the NF 200 and the prepaid slice information about the UE. For example, in case that the UE uses all data as much as the amount of available data included in the prepaid slice information, the UDM/UDR 145 may determine to no longer provide the prepaid slice to the UE 100. Accordingly, the UDM/UDR 145 may transmit a subscription update notification message to the AMF 120. The subscription update notification message may include information indicating that the prepaid slice (e.g., S-NSSAI 10) is no longer available. For example, because the UE used the data usage included in the prepaid slice information, the UDM/UDR 145 may delete the prepaid slice (e.g., S-NSSAI 10) in a subscribed slice (subscribed S-NSSAIs) and transmit information about a newly determined subscribed slice to the AMF 120. Alternatively, the UDM/UDR 145 may transmit, to the AMF 120, information/an indicator indicating that the prepaid slice is no longer available.

Step 618: The AMF 120 that has transmitted the information about the allowed slice including the prepaid slice (e.g., S-NSSAI 10) to the UE registered in the 5G network through the procedure illustrated in FIG. 2 (see S224 and S226 of FIG. 2) may determine to update prepaid slice information (update a UE configuration). For example, the AMF 120 may identify that the prepaid slice is no longer available based on the information received in step 616. Accordingly, the AMF 120 may determine to delete the prepaid slice from the allowed slice. For reference, the allowed slice (allowed NSSAI) may include the public slice (S-NSSAI) and/or the prepaid slice (S-NSSAI). The allowed slice includes one or more S-NSSAIs. That is, the public slice and/or the prepaid slice may be included as one S-NSSAI in the allowed slice.

Step 620: The AMF 120 may transmit a UE configuration update message including information (new allowed NSSAI) about a new allowed slice with the prepaid slice deleted, to the UE 100.

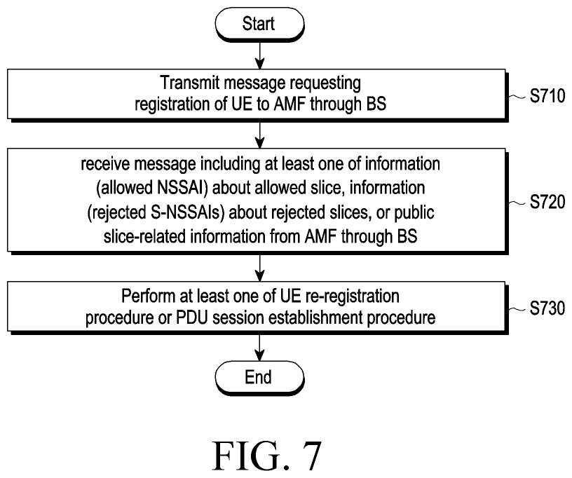

FIG. 7 is a flowchart illustrating an operation of a UE according to an embodiment of the disclosure.

Referring to FIG. 7, the UE 100 may transmit a message requesting registration of the UE to the AMF 120 via the BS 110 at operation S710. For detailed operations related to operation S710, refer to steps 210, 212 and 214 of FIG. 2.

After operation S710, the UE 100 may receive a message including at least one of information (allowed NSSAI) about an allowed slice, information (rejected S-NSSAIs) about rejected slices, or public slice information from the AMF 120 via the BS 110 at operation S720. The information about the allowed slice may include the public slice information. For detailed operations related to operation S720, refer to steps 224 and 226 of FIG. 2. As the UE 100 receives the message, the UE registration procedure is completed.

After operation S720, the UE 100 may perform at least one of a UE re-registration procedure or a PDU session establishment procedure at operation S730. For detailed operations related to operation S730, refer to FIGS. 3 and 4.

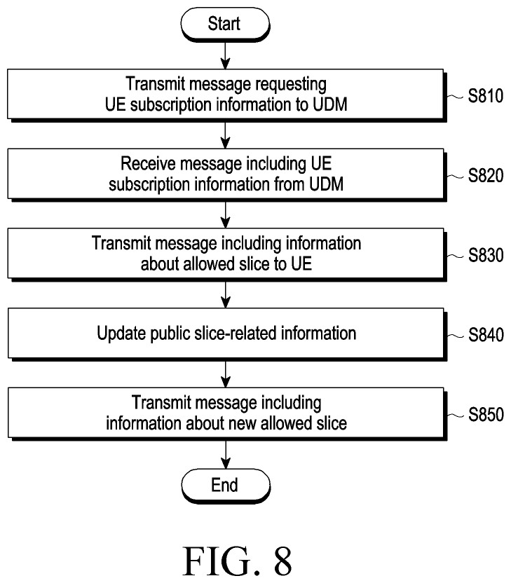

FIG. 8 is a flowchart illustrating an operation of an AMF according to an embodiment of the disclosure.

Referring to FIG. 8, the AMF 120 may transmit a message requesting UE subscription information to the UDM 145 at operation S810. For a detailed operation related to operation S810, refer to step 216 of FIG. 2.

After operation S810, the AMF 120 may receive a message including the UE subscription information from the UDM 145 at operation S820. The UE subscription information may include subscribed slice information and/or prepaid slice information of the UE. For a detailed operation related to operation S820, refer to step 218 of FIG. 2.

After operation S820, the AMF 120 may transmit a message including information about an allowed slice to the UE 100 at operation S830. For detailed operations related to operation S830, refer to steps 224 and 226 of FIG. 2.

When a time and the location of the UE 100 are changed, the AMF 120 may update public slice information after operation S830 at operation S840. For a detailed operation related to operation S840, refer to step 512 of FIG. 5.

After operation S840, the AMF 120 may transmit a message including information about a new allowed slice to the UE 100 at operation S850. For a detailed operation related to operation S850, refer to step 514 of FIG. 2.

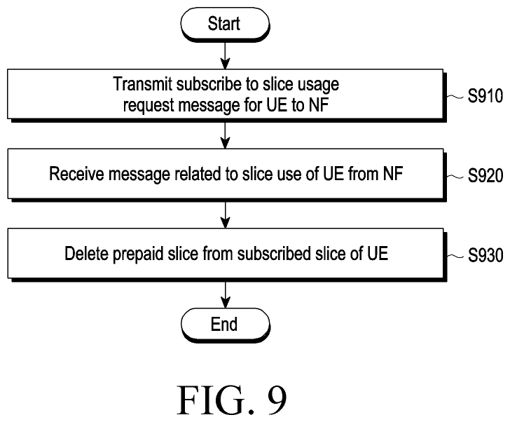

FIG. 9 is a flowchart illustrating an operation of a UDM/UDR according to an embodiment of the disclosure.

Referring to FIG. 9, the UDM/UDR 145 may transmit a subscribe to slice usage request message for the UE to the NF 200 at operation S910. For a detailed operation related to operation S910, refer to step 610 of FIG. 6.

When a data usage of the UE 100 reaches a threshold, that is, in case that the UE 100 uses all data as much as a predetermined amount of available data included in prepaid slice information, the UDM/UDR 145 may receive a message related to the slice use of the UE from the NF 200 after operation S910 at operation S920. For a detailed operation related to operation S920, refer to step 614 of FIG. 6.

in case that the UE 100 uses all data as much as the predetermined amount of available data included in the prepaid slice information, the UDM/UDR 145 may delete a prepaid slice from a subscribed slice of the UE after operation S920 at operation S930. For a detailed operation related to operation S930, refer to step 616 of FIG. 6. The subscribed slice (subscribed S-NSSAIs) means network slices to which the UE has subscribed. Since a prepaid slice (S-NSSAI) is a slice subscribed to by the UE trough prepayment, it is included in the subscribed slice. On the other hand, since the public slice is a slice available to all UEs at a specific location and time regardless of UEs, it is not included in the subscribed slice.

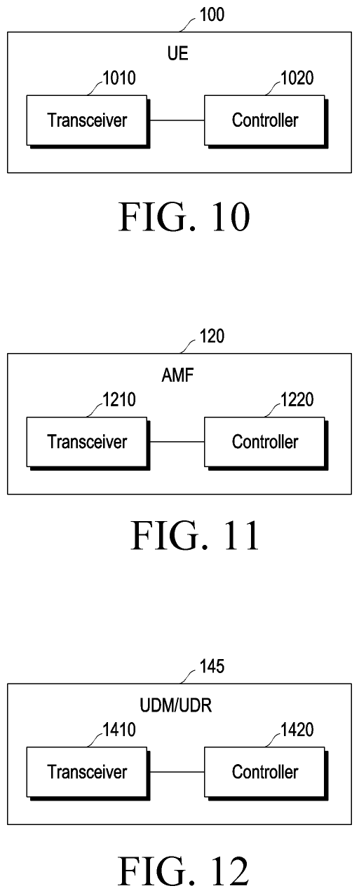

FIG. 10 is a block diagram illustrating a UE according to an embodiment of the disclosure.

Referring to FIG. 10, for example, the UE 100 may include a transceiver 1010 and a controller 1020 coupled to the transceiver 1010. The controller 1020 may provide overall control to the operations of the UE 100 according to at least one of the embodiments of FIGS. 1 to 9.

FIG. 11 is a block diagram illustrating an AMF according to an embodiment of the disclosure.

Referring to FIG. 11, for example, the AMF 120 may include a transceiver 1210 and a controller 1220 coupled to the transceiver 1210. The controller 1220 may provide overall control to the operations of the AMF 120 according to at least one of the embodiments of FIGS. 1 to 9.

FIG. 12 is a block diagram illustrating a UDM/UDR according to an embodiment of the disclosure.

Referring to FIG. 12, for example, the UDM/UDR 145 may include a transceiver 1410 and a controller 1420 coupled to the transceiver 1410. The controller 1420 may provide overall control to the operations of the UDM/UDR 145 according to at least one of the embodiments of FIGS. 1 to 9.

While the disclosure has been shown and describe with reference to various embodiments thereof, it will be understood by those skilled in the art that various changes in form and details may be made therein without departing from the spirit and scope of the disclosure as defined by the appended claims and their equivalents.

What is claimed is:

1. A method for providing a network slice performed by a user equipment (UE) in a wireless communication system, the method comprising:
transmitting a first message requesting registration of the UE to a first network entity via a base station (BS);
receiving a second message including information indicating that the registration of the UE is accepted from the first network entity via the BS in response to the transmission of the first message, wherein the second message further includes information indicating an allowed network slice; and
performing communication based on the information indicating the allowed network slice.

2. The method of claim 1, further comprising:
performing a protocol data unit (PDU) session establishment procedure in response to the reception of the second message,
wherein performing the PDU session establishment procedure comprises:
transmitting a third message requesting a PDU session using a public network slice to the first network entity via the BS, wherein the third message includes information indicating the public network slice that the UE intends to use, and
receiving a fourth message including information indicating that establishment of the PDU session is accepted from the first network entity via the BS in response to the transmission of the third message, and
wherein in case that the public network slice is a network slice included in UE subscription information, the PDU session is established.

3. The method of claim 1, further comprising:
performing a re-registration procedure of the UE in response to the reception of the second message,
wherein performing the re-registration procedure of the UE comprises:
transmitting a fifth message including information indicating a public network slice that the UE intends to use to the first network entity, and
receiving a sixth message including information indicating a public network slice available to the UE from the first network entity in response to the transmission of the fifth message, and
wherein the public network slice available to the UE further includes a new allowed network slice.

4. The method of claim 1, further comprising:
receiving a sixth message from the first network entity, wherein the sixth message includes information indicating that a public network slice is available or information indicating that the public network slice is unavailable; and
updating information related to the public network slice based on the sixth message.

5. The method of claim 1, further comprising:
receiving a seventh message from the first network entity,
wherein the seventh message includes information indicating a new allowed network slice in which a prepaid network slice is deleted.

6. A method for providing a network slice performed by a first network entity in a wireless communication system, the method comprising:
receiving a first message requesting registration of a user equipment (UE) from the UE;
transmitting a second message requesting UE subscription information to a second network entity in response to the reception of the first message;
receiving a third message including the UE subscription information from the second network entity in response to the transmission of the second message, wherein the UE subscription information includes information indicating a network slice subscribed to by the UE and a prepaid network slice; and
transmitting a fourth message including information indicating an allowed network slice to the UE based on the UE subscription information.

7. The method of claim 6, further comprising:
receiving a fifth message for a protocol data unit (PDU) session establishment request of the UE from the UE via a base station (BS), wherein the fifth message includes information related to a public network slice requested for PDU session establishment by the UE;
forwarding the fifth message to the second network entity;
receiving a sixth message including information indicating that PDU session establishment is allowed based on the information related to the public network slice from the second network entity, in response to the forwarding of the fifth message; and
forwarding the sixth message to the UE via the BS.

8. The method of claim 6, further comprising:
receiving a seventh message including changed information related to a public network slice from a third network entity;
updating information related to the public network slice based on the seventh message; and
transmitting an eighth message including information indicating a new allowed network slice in which the public network slice is deleted to the UE in response to the update.

9. The method of claim 6, further comprising:
in case that the UE uses a predetermined amount of available data included in information related to the prepaid network slice, receiving a ninth message including information indicating that the prepaid network slice is unavailable from the second network entity;
updating the information related to the prepaid network slice in response to the reception of the ninth message; and
transmitting a tenth message including information indicating a new allowed network slice in which the prepaid network slice is deleted to the UE in response to the update.

10. A user equipment (UE) for providing a network slice in a wireless communication system, the UE comprising:
a transceiver; and
a controller coupled to the transceiver,
wherein the controller is configured to:
transmit a first message requesting registration of the UE to a first network entity via a base station (BS),
receive a second message including information indicating that the registration of the UE is accepted from the first network entity via the BS in response to the transmission of the first message, wherein the second message further includes information indicating an allowed network slice, and
perform communication based on the information indicating the allowed network slice.

11. The UE of claim 10,
wherein the controller is configured to perform a protocol data unit (PDU) session establishment procedure in response to the reception of the second message,
wherein to perform the PDU session establishment procedure, the controller is configured to:
transmit a third message requesting a PDU session using a public network slice to the first network entity via the BS, wherein the third message includes information indicating the public network slice that the UE intends to use, and
receive a fourth message including information indicating that establishment of the PDU session is accepted from the first network entity via the BS in response to the transmission of the third message, and
wherein in case that the public network slice is a network slice included in UE subscription information, the PDU session is established.

12. The UE of claim 10,
wherein the controller is configured to perform a re-registration procedure of the UE in response to the reception of the second message,
wherein to perform the re-registration procedure of the UE, the controller is configured to:
transmit a fifth message including information indicating a public network slice that the UE intends to use to the first network entity, and
receive a sixth message including information indicating a public network slice available to the UE from the first network entity in response to the transmission of the fifth message, and
wherein the public network slice available to the UE further includes a new allowed network slice.

13. The UE of claim 10, wherein the controller is configured to:
receive a seventh message from the first network entity, wherein the seventh message includes information indicating that a public network slice is available or information indicating that the public network slice is unavailable; and
update information related to the public network slice based on the seventh message.

14. The UE of claim 10,
wherein the controller is configured to receive an eighth message from the first network entity, and
wherein the eighth message includes information indicating a new allowed network slice in which a prepaid network slice is deleted.

15. A first entity for providing a network slice in a wireless communication system, the first entity comprising:
a transceiver; and
a controller coupled to the transceiver,
wherein the controller is configured to:
receive a first message requesting registration of a user equipment (UE) from the UE,
transmit a second message requesting UE subscription information to a second network entity in response to the reception of the first message,
receive a third message including the UE subscription information from the second network entity in response to the transmission of the second message, wherein the UE subscription information includes information indicating a network slice subscribed to by the UE and a prepaid network slice, and
transmit a fourth message including information indicating an allowed network slice to the UE based on the UE subscription information.

16. The first entity of claim 15, wherein the controller is configured to:
receive a fifth message for a protocol data unit (PDU) session establishment request of the UE from the UE via a base station (BS), wherein the fifth message includes information related to a public network slice requested for PDU session establishment by the UE;
forward the fifth message to the second network entity;
receive a sixth message including information indicating that PDU session establishment is allowed based on the information related to the public network slice from the second network entity, in response to the forwarding of the fifth message; and
forward the sixth message to the UE via the BS.

17. The first entity of claim 15, wherein the controller is configured to:
receive a seventh message including changed information related to a public network slice from a third network entity;
update information related to the public network slice based on the seventh message; and
transmit an eighth message including information indicating a new allowed network slice in which the public network slice is deleted to the UE in response to the update.

18. The first entity of claim 15, wherein the controller is configured to:
in case that the UE uses all data as much as a predetermined amount of available data included in information related to the prepaid network slice, receive a ninth message including information indicating that the prepaid network slice is unavailable from the second network entity;
update the information related to the prepaid network slice in response to the reception of the ninth message; and
transmit a tenth message including information indicating a new allowed network slice in which the prepaid network slice is deleted to the UE in response to the update.
